(19) United States
(12) Patent Application Publication
(10) Pub. No.: US 2025/0104162 A1
(43) Pub. Date: Mar. 27, 2025

(54) APPARATUS AND METHOD FOR MANAGING CREATOR CAMPAIGNS

(71) Applicant: NEXON KOREA CORPORATION, Seongnam-si (KR)

(72) Inventors: Yangjin CHO, Seongnam-si (KR); Jongkeun CHOI, Seongnam-si (KR); Suyoung JANG, Seongnam-si (KR); Jokang HEO, Seongnam-si (KR); Geonyoung KIM, Seongnam-si (KR); Young Jin KIM, Seongnam-si (KR); Suyeon SHIN, Seongnam-si (KR); Eun Ji JANG, Seongnam-si (KR); Bomin LEE, Seongnam-si (KR); Byungdoo YUN, Seongnam-si (KR); Seoyoung JI, Seongnam-si (KR); Jongha JEON, Seongnam-si (KR); Wonil KWAK, Seongnam-si (KR); Jihun KIM, Seongnam-si (KR); Seong Mok JEONG, Seongnam-si (KR); Sora YEON, Seongnam-si (KR); Seong Ho JIN, Seongnam-si (KR); Junho MOON, Seongnam-si (KR); Eun YU, Seongnam-si (KR); Taekyung LEE, Seongnam-si (KR); Jeehun CHOI, Seongnam-si (KR); Taeyoung KIM, Seongnam-si (KR); Junbeom AN, Seongnam-si (KR); Junwon KIM, Seongnam-si (KR); Dong hyeon KIM, Seongnam-si (KR)

(21) Appl. No.: 18/895,977

(22) Filed: Sep. 25, 2024

(30) Foreign Application Priority Data
Sep. 26, 2023 (KR) 10-2023-0129802

(51) Int. Cl. G06Q 50/00; G06Q 30/0226

(52) U.S. Cl. CPC G06Q 50/01; G06Q 30/0232

(57) ABSTRACT

The embodiments disclosed herein are directed to an apparatus and method for managing creator campaigns. According to an aspect of the embodiments, there is provided an apparatus for managing creator campaigns, the apparatus including: memory; and a controller configured to provide a creator campaign and provide a reward to a supporter for a creator who has completed performing the creator campaign.

### CROSS-REFERENCE TO RELATED APPLICATION

This application claims the benefit of Korean Patent Application No. 10-2023-0129802 filed on Sep. 26, 2023, which is hereby incorporated by reference herein in its entirety.

### BACKGROUND

### 1. Technical Field

The embodiments disclosed herein relate to an apparatus and method for managing creator campaigns, and more particularly to a creator campaign managing apparatus and method that may provide rewards to a creator and a supporter when the creator completes performing a creator campaign.

### 2. Description of the Related Art

Creators refer to people who create video content on various topics such as games, food, and reviews or who do personal broadcasting on a streaming platform that enables real-time broadcasting. As an example, among creators, a game creator who broadcasts on the topic of games may stream the playing of a specific game in real time.

Among the viewers of a creator's personal broadcast or video content, some subscribe to the channel where the creator's video content is uploaded in order to regularly watch the creator's personal broadcast or video content, and some support the creator by donating a specific amount of money during the creator's personal broadcast or by ordering the creator to perform a mission and then donating a specific amount of money in return for the success of the mission. In connection with this, Korean Patent Application Publication No. 10-2020-0013887 discloses an apparatus and method that allow the sponsorship money provided by one or more viewers to be paid to a creator depending on whether a target mission is achieved.

Meanwhile, creators may sometimes hold events for viewers to gather viewers for their personal broadcasts or maintain viewers and provide rewards to viewers who meet specific conditions. However, these events are one-time events, and have a disadvantage in that it is difficult to expect the effect of strengthening the ties between viewers and creators through the events. Furthermore, there is also a problem in that it is difficult for creators to provide separate benefits to regular viewers and supporters because it is difficult to distinguish regular viewers who regularly watch creators' broadcasts and supporters who support creators from simple viewers.

Therefore, there is a demand for a new level of function to overcome the above-described problems.

Meanwhile, the above-described background technology corresponds to technical information that has been possessed by the present inventor in order to contrive the present invention or that has been acquired in the process of contriving the present invention, and can not necessarily be regarded as well-known technology that had been known to the public prior to the fling of the present invention.

### SUMMARY

An object of the embodiments disclosed herein is to provide a creator campaign managing apparatus and method that may provide rewards to both a creator and a supporter when the creator completes performing a creator campaign.

According to an aspect of the present invention, there is provided an apparatus for managing creator campaigns, the apparatus including: memory; and a controller configured to provide a creator campaign and provide a reward to a supporter for a creator who has completed performing the creator campaign.

According to another aspect of the present invention, there is provided a method of managing creator campaigns, the method being performed by an apparatus for managing creator campaigns, the method including: providing a creator campaign; and providing a reward to a supporter for a creator who has completed performing the creator campaign.

According to still another aspect of the present invention, there is provided a non-transitory computer-readable storage medium having stored thereon a program that, when executed by a processor, causes the processor to execute a method of managing creator campaigns, wherein the method includes providing a creator campaign, and providing a reward to a supporter for a creator who has completed performing the creator campaign.

According to still another aspect of the present invention, there is provided a computer program that is executed by an apparatus for managing creator campaigns and stored in a non-transitory computer-readable storage medium to perform a method of managing creator campaigns, wherein the method includes providing a creator campaign, and providing a reward to a supporter for a creator who has completed performing the creator campaign.

According to any one of the above-described solutions, rewards may be provided not only to a creator who has completed performing a creator campaign but also to a supporter for the creator, and thus the supporter may also share the benefits of the creator's completion of performance of the campaign, so that the ties between the creator and the supporter can be strengthened.

According to any one of the above-described solutions, a supporter may support a creator by using the viewer points received as a reward for the creator's completion of performance of a campaign, so that the creator can be supported without incurring separate costs and there can be formed a virtuous cycle structure in which the profits obtained from the creator are provided back to the creator.

According to any one of the above-described solutions, there may be required a number of participation items equal to the number of participation items set for a creator campaign and participation items may only be used within a set usage limit for a set period of time, so that there is an advantage in that a specific creator can be prevented from having a monopoly.

The effects that can be obtained by the embodiments disclosed herein are not limited to the above-described effects, and other effects that have not been described above will be clearly understood by those having ordinary skill in the art, to which the disclosed embodiments pertain, from the following description.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram illustrating a system for managing creator campaigns according to an embodiment;

FIG. 2 is a block diagram illustrating an apparatus for managing creator campaigns according to an embodiment;

FIG. 3 is a diagram illustrating a creator campaign interface according to an embodiment;

FIG. 4 is a diagram illustrating a creator campaign participation reservation according to an embodiment;

FIG. 5 is a diagram illustrating participation items according to an embodiment;

FIG. 6 is a diagram illustrating the submission of campaign content according to an embodiment;

FIG. 7 is a diagram illustrating a supporter-dedicated interface according to an embodiment;

FIG. 8 is a diagram illustrating support for a creator using the viewer points of a supporter according to an embodiment;

FIG. 9 is a diagram illustrating the exchange of participation items and level-up items according to an embodiment;

FIG. 10 is a flowchart illustrating a method of managing creator campaigns according to an embodiment; and

FIG. 11 is a flowchart illustrating a process of managing the level and grade of a creator by a method of managing creator campaigns according to an embodiment.

### DETAILED DESCRIPTION

Various embodiments will be described in detail below with reference to the accompanying drawings. The following embodiments may be modified to various different forms and then practiced. In order to more clearly illustrate features of the embodiments, detailed descriptions of items that are well known to those having ordinary skill in the art to which the following embodiments pertain will be omitted. Furthermore, in the drawings, portions unrelated to descriptions of the embodiments will be omitted. Throughout the specification, like reference symbols will be assigned to like portions.

Throughout the specification, when one component is described as being “connected” to another component, this includes not only a case where the one component is ‘directly connected’ to the other component but also a case where the one component is ‘connected to the other component with a third component arranged therebetween.’ Furthermore, when one portion is described as “including” one component, this does not mean that the portion does not exclude another component but means that the portion may further include another component, unless explicitly described to the contrary.

Embodiments will be described in detail below with reference to the accompanying drawings.

Meanwhile, prior to the following description, the meanings of the terms to be used below will be defined first.

First, the term “creator” refers to a person who creates content to be uploaded to an online platform. For example, creators include people who produce and upload videos or broadcast (hereinafter referred to as “stream”) their own games, talks, mukbangs, or the like in real time on Internet broadcasting platforms such as YouTube, Twitch, and AfreecaTV. Recently, people who create and upload short video content of less than 1 minute on TikTok, Instagram Reels, and YouTube Shorts are also encompassed in the category of creators.

The term “support code” refers to a code that is used to identify a creator who is a target of support within an apparatus for managing creator campaigns according to an embodiment. A support code may be assigned to each creator.

The term “supporter” refers to a person who supporters a creator through an apparatus for managing creator campaigns according to an embodiment. A supporter can become a supporter for a creator by registering a support code assigned to the creator.

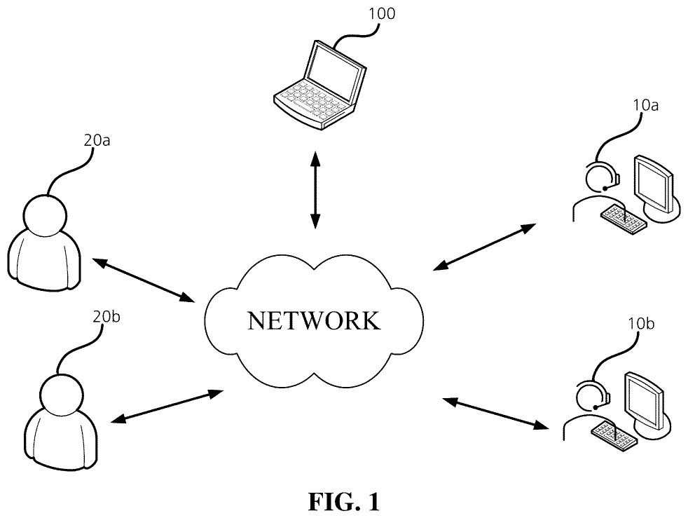

FIG. 1 is a block diagram illustrating a system for managing creator campaigns according to an embodiment. Referring to FIG. 1, an apparatus 100 for managing creator campaigns may communicate with electronic terminals of creators 10a and 10b and supporters 20a and 20b over a network.

The apparatus 100 for managing creator campaigns may provide creator campaigns to the creators 10a and 10b, and may provide rewards to the creators 10a and 10b and supporters for the creators 10a and 10b when the creators 10a and 10b complete performing the creator campaigns. For example, when supporter X 20a is a supporter for creator A 10a and creator A 10a completes performing a creator campaign, the apparatus 100 for managing creator campaigns may provide rewards to creator A 10a and supporter X 20a for creator A 10a, respectively. In this case, the apparatus 100 for managing creator campaigns may provide different types of rewards to creator A 10a and supporter X 20a for creator A 10a, respectively.

The apparatus 100 for managing creator campaigns may provide a creator campaign and an opportunity to participate in the creator campaign only to a creator registered as a creator member. The creator campaign may belong to one of a plurality of campaign types classified according to the difficulty to perform thereof. Furthermore, the apparatus 100 for managing creator campaigns may deduct a specific number of participation items, set for each campaign, from the participation items held by a creator member when the creator member participates in the campaign.

The apparatus 100 for managing creator campaigns may register a creator, who has applied for membership registration, as a creator member, and may register a supporter, who has registered a support code assigned to a creator member, as a supporter member. According to an embodiment, the apparatus 100 for managing creator campaigns may introduce self-authentication so that one support code can be granted to one creator. Meanwhile, the apparatus 100 for managing creator campaigns may allow one supporter to register a plurality of support codes, thereby enabling the supporter to supporter a plurality of creators.

According to an embodiment, the apparatus 100 for managing creator campaigns may access the service provided by a creator supporting apparatus (not shown) while operating in conjunction with the creator supporting apparatus (not shown), and may receive the creator membership information and supporter membership information registered in the creator supporting apparatus (not shown). Accordingly, when a creator member or supporter member registered in the creator supporting apparatus (not shown) applies for membership registration in the apparatus 100 for managing creator campaigns, a corresponding creator or supporter may be registered as a creator member or supporter member for the apparatus 100 for managing creator campaigns without the separate entry of additional information. In this case, the creator supporting apparatus is an apparatus for providing a service that supports a creator by registering the creator's support code in a supporter's account, like the apparatus 100 for managing creator campaigns. For example, the creator supporting apparatus may be an apparatus that provides the creator corresponding to the registered support code with part of the sales, generated by a supporter who has registered the specific creator's support code, as support money. In this case, the sales generated by the supporter may be a purchase amount for items or cash sold within a game providing apparatus (not shown). The creator supporting apparatus (not shown) may receive the purchase history and purchase amount of the supporter for items or cash sold within the game providing apparatus (not shown) while communicating with the game providing apparatus (not shown).

Meanwhile, the apparatus 100 for managing creator campaigns and the creator supporting apparatus (not shown) may be included in the game providing apparatus (not shown), or may include the game providing apparatus (not shown). In this case, the game providing apparatus (not shown) may enable a game to be played in a time-series manner by storing game space information, game scenario information, game quest information, and various types of information related to the playing of the game and also detecting and recording various events occurring in the game.

Furthermore, the game providing apparatus (not shown) may provide a game user with various items that can be applied to game objects held by the game user in the playing of the game or can be used during the playing of the game. Some of these items may be acquired through payment by the game user. For this purpose, game item sales, cash sales, or the like may be performed. Some of the items provided to the game user may be provided to the creator and the supporter for the creator as a reward upon completion of performance of the creator campaign.

When the apparatus 100 for managing creator campaigns is included in the game providing apparatus (not shown), the supporter may access content related to a game provided by the game providing apparatus (not shown), campaign content, or a creator broadcast through a menu provided within a game screen provided by the game providing apparatus (not shown), and may also check the items provided as a reward for the completion of performance of the creator campaign. Furthermore, the creator may check the creator campaigns that can be participated in through the menu provided within the game screen provided by the game providing apparatus (not shown), or may also check the items provided as a reward for the completion of performance of the creator campaign.

When the apparatus 100 for managing creator campaigns is implemented as an apparatus separate from the game providing apparatus (not shown), it may transmit and receive information for the performance of a method of managing creator campaigns while communicating with the game providing apparatus (not shown). For example, the apparatus 100 for managing creator campaigns may transmit the creator's creator campaign performance completion information and the creator's supporter information to the game providing apparatus (not shown). The game providing apparatus (not shown) may provide the items, set as rewards for the creator campaign, to accounts within the game providing apparatus used by the creator and the supporter for the creator.

The apparatus 100 for managing creator campaigns may manage one or more creators and one more supporters registered as members, i.e., creator members and supporter members. More specifically, the apparatus 100 for managing creator campaigns may operate a level system for creator members. The apparatus 100 for managing creator campaigns may set the level of a creator member to a basic level, such as level 1, upon registration of the creator member, may provide experience points to the creator member whenever the creator member completes performing a campaign, and may increase the level when the experience points possessed by the creator member exceed a preset reference. Furthermore, the apparatus 100 for managing creator campaigns may provide one or more level-up items as a reward for an increase in the level when the level of the creator member increases, and may also allow the level-up items, possessed by the creator member, to be exchanged for participation items.

In addition, the apparatus 100 for managing creator campaigns may grant a creator grade based on the level of the creator member, and may provide benefits based on the creator grade to the creator member. In this case, the benefits provided to the creator member may be differentially provided according to the creator grade. For example, the number of participation items provided to the creator member at regular intervals may be differentially set according to the creator grade.

Furthermore, the apparatus 100 for managing creator campaigns may grant a supporter grade to a supporter member and provide benefits to the supporter member according to the supporter grade. Like benefits for a creator member, benefits provided to the supporter member may be differentially provided according to the supporter grade granted to the supporter member. For example, the apparatus 100 for managing creator campaigns may differentially provide items, which can be purchased with viewer points, according to the supporter grade.

The apparatus 100 for managing creator campaigns may transmit and receive information for the performance of a method of managing creator campaigns while additionally communicating with a third-party server (not shown). For example, the apparatus 100 for managing creator campaigns may access the service provided by the third-party server (not shown) while operating in conjunction with the third-party server (not shown). In this case, the third-party server (not shown) may provide video content and real-time broadcasting services like YouTube and AfreecaTV. For example, the apparatus 100 for managing creator campaigns may determine whether a creator participates in a campaign by transmitting the content unique address of campaign content, received from the creator, to the third-party server (not shown) and receiving the campaign content corresponding to the content unique address, and may also provide campaign content information uploaded to the third-party server (not shown) to supporters or allow supporters to play back the campaign content within the apparatus 100 for managing creator campaigns. Furthermore, information about whether the creator is broadcasting may be received from the third-party server (not shown), and supporters may be allowed to watch the creator's broadcast through a separate interface.

The apparatus 100 for managing creator campaigns may be implemented as an electronic terminal having an application installed therein, or may be implemented as a server-client system. When the apparatus 100 for managing creator campaigns is implemented as a server-client system, it may include electronic terminals having clients for interaction among supporters, creators and an administrator installed therein.

In this case, each of the electronic terminals may be implemented as a computer, a mobile terminal, a television, a wearable device, or the like that can include an interface capable of enabling interaction among the supporters, the creators and the administrator. In this case, the computer includes, e.g., a notebook, a desktop, a laptop, and the like each equipped with a web browser. The mobile terminal is, e.g., a wireless communication device capable of guaranteeing portability and mobility, and may include all types of handheld wireless communication devices, such as a Personal Communication System (PCS) terminal, a Personal Digital Cellular (PDC) terminal, a Personal Handphone System (PHS) terminal, a Personal Digital Assistant (PDA), a Global System for Mobile communications (GSM) terminal, an International Mobile Telecommunication (IMT)-2000 terminal, a Code Division Multiple Access (CDMA)-2000 terminal, a W-Code Division Multiple Access (W-CDMA) terminal, a Wireless Broadband (Wibro) Internet terminal, a smartphone, a Mobile Worldwide Interoperability for Microwave Access (mobile WiMAX) terminal, and the like. Furthermore, the television may include an Internet Protocol Television (IPTV), an Internet Television (Internet TV), a terrestrial TV, a cable TV, and the like. Moreover, the wearable device is an information processing device of a type that can be directly worn on a human body, such as a watch, glasses, an accessory, clothing, shoes, or the like, and can access a remote server or be connected to another terminal directly or via another information processing device over a network.

In addition, the server may be implemented as a computing device capable of communicating through the electronic terminals, each having a client for interaction with the supporters, the creators and the administrator installed therein, and a network, and may include a storage device capable of storing data or store data through a third-party server.

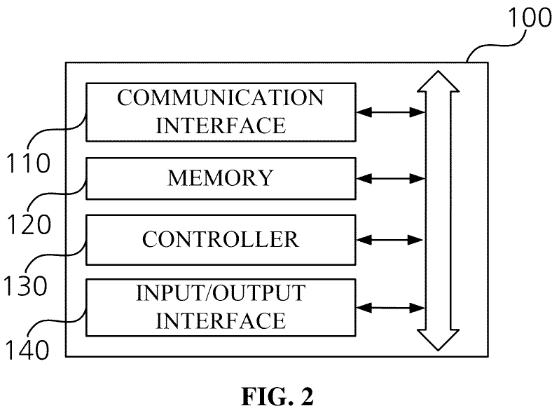

FIG. 2 is a block diagram illustrating an apparatus for managing creator campaigns according to an embodiment.

Referring to FIG. 2, an apparatus 100 for managing creator campaigns according to an embodiment may include a communication interface 110, memory 120, a controller 130, and an input/output interface 140.

The communication interface 110 may perform wired/wireless communication with another device or a network. To this end, the communication interface 110 may include a communication module that supports at least one of various wired/wireless communication methods. For example, the communication module may be implemented in the form of a chipset.

In this case, the wireless communication supported by the communication interface 110 may be, e.g., Wireless Fidelity (Wi-Fi), Wi-Fi Direct, Bluetooth, Ultra-Wide Band (UWB), Near Field Communication (NFC), or the like. Furthermore, the wired communication supported by the communication interface 110 may be, e.g., Universal Serial Bus (USB), High Definition Multimedia Interface (HDMI), or the like.

According to an embodiment, the communication interface 110 may receive data for the performance of a method of managing creator campaigns from the third-party server or the creator supporting apparatus (not shown), and conversely, may transmit data for the performance of a method of managing creator campaigns to the third-party server or the creator supporting apparatus (not shown) In connection with this, various types of data such as applications and programs may be installed and stored in the memory 120. For example, a program required for managing creator campaigns, a program required for managing creator members and supporter members, and data may be stored. Furthermore, the memory 120 may store the personal information of creator members and supporter members and the support information received from the creator supporting apparatus (not shown). The controller 130 to be described below may access and use data stored in the memory 120, or may store new data in the memory 120. Furthermore, the controller 130 may execute a program installed in the memory 120. For example, the memory 120 may install a program for performing a method of managing creator campaigns such as the types of creator campaigns, a creator member level system, criteria for increases in creator grade, and a supporter grading system. Furthermore, the controller 130 may perform a method of managing creator campaigns by executing an program stored in the memory 120.

The input/output interface 140 may include an operation panel configured to receive user input and a display panel configured to display screens.

More specifically, the input interface may include devices capable of receiving various types of user input such as a keyboard, physical buttons, a touch screen, a camera, and a microphone. Furthermore, the output interface may include a display panel, and/or a speaker. However, the input/output interface 140 is not limited thereto, and may include components capable of supporting various types of input/output.

Meanwhile, the controller 130 includes at least one processor, by executing a program stored in the memory 120, may control the overall operation of the apparatus 100 for managing creator campaigns, and may provide a creator campaign to a creator and provide rewards to the creator and a supporter for the creator when performing the creator campaign is completed. Meanwhile, the controller 130 may provide a creator campaign and an opportunity to participate in the creator campaign only to a creator registered as a creator member. The controller 130 may also receive an application for the registration of creator membership directly from a creator. The controller 130 may register a creator member without a separate approval procedure after an application for membership registration, or may register a creator as a creator member only when the creator meets preset qualification requirements. The controller 130 may issue a support code to a creator registered as a creator member, and may register a supporter, who has registered a support code assigned to a creator member, as a supporter member.

As described above in conjunction with FIG. 1, the controller 130 may register a specific creator as a creator member based on the creator member information received from the creator supporting apparatus. The controller 130 may register a creator, who has applied for membership registration, as a creator member without the entry of additional information based on the received creator member information and supporter member information. When there is a support code already assigned by the creator supporting apparatus, the controller 130 may allow the use of the support code already assigned by the creator supporting apparatus without the assignment of a separate support code.

Hereinafter, unless otherwise stated, the creators and supporters described herein are creators and supporters registered as members in the apparatus 100 for managing creator campaigns, i.e., creator members and supporter members.

The controller 130 may provide creator campaigns to creators through a creator campaign-dedicated page.

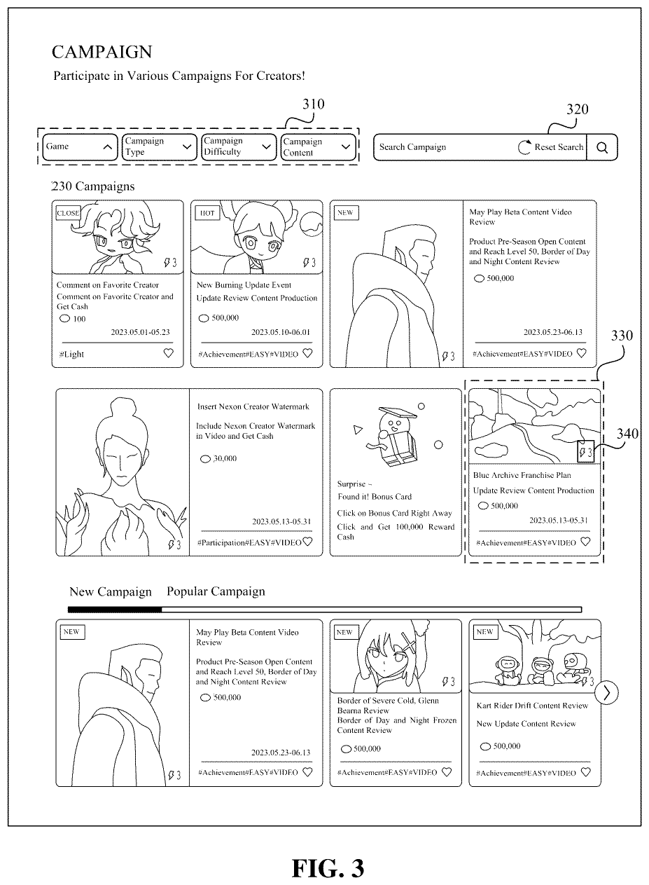

FIG. 3 is a diagram illustrating a creator campaign interface according to an embodiment. Referring to FIG. 3, the creator campaign interface may include a plurality of search options 310 such as a game name, a campaign type, a campaign difficulty, and campaign content, a search box 320 configured to receive a search term related to a campaign, and a plurality of campaign cards 330. Furthermore, as shown in FIG. 3, new campaign and popular campaign tabs may be provided such that a creator can rapidly search for a newly registered campaign and a currently popular campaign. Moreover, the creator campaign interface may provide personalized campaign content for each creator.

A participation type is the second lowest difficulty campaign type, and may be a campaign type that does not require high content creation difficulty. As an example, a participation type of campaign may be designed to insert a watermark image into a broadcast video or video content being produced. An achievement type of campaign is a campaign that is designed to produce content that performs a mission related to a specific topic, such as performing a quest or a review of an update. A competition type is the type of campaign in which a creator competes with other creators, and a competition type of campaign is designed to create a league and perform playing. A participation of campaign, a competition of campaign, and an achievement type of campaign each require a process of registering campaign content for the participation in the creator campaign and receiving a judgment for the completion of performance of the creator campaign, and rewards may be provided to a creator who has executed the campaign and a supporter for the creator when the creator campaign is judged to be completed.

Meanwhile, the types of creator campaigns may further include a mini reward type that provides an immediate reward when a randomly distributed card is found within a platform. Unlike other types that require the registration of campaign content for participation in a creator campaign and the judgment for the completion of performance, the mini reward type may provide an immediate reward upon performing a creator campaign.

The controller 130 may set a participation reservation for a campaign that is selected by a creator. For example, when a creator selects one of the campaign cards displayed on the creator interface of FIG. 3, the controller 130 may provide the creator with a message box, asking whether to make a participation reservation for a selected campaign, including a participation reservation button. When the creator presses the participation reservation button, the controller 130 may make a participation reservation for the campaign selected by the creator. The controller 130 may provide an additional reward to the creator when the creator completes performing the reserved campaign. For example, the controller 130 may additionally provide 20% of a previously proposed campaign reward as an additional reward when the creator completes performing the campaign within a campaign participation period.

Furthermore, the controller 130 may provide a creator with information about a creator campaign, for which participation has been reserved, by marking it on a schedule or calendar.

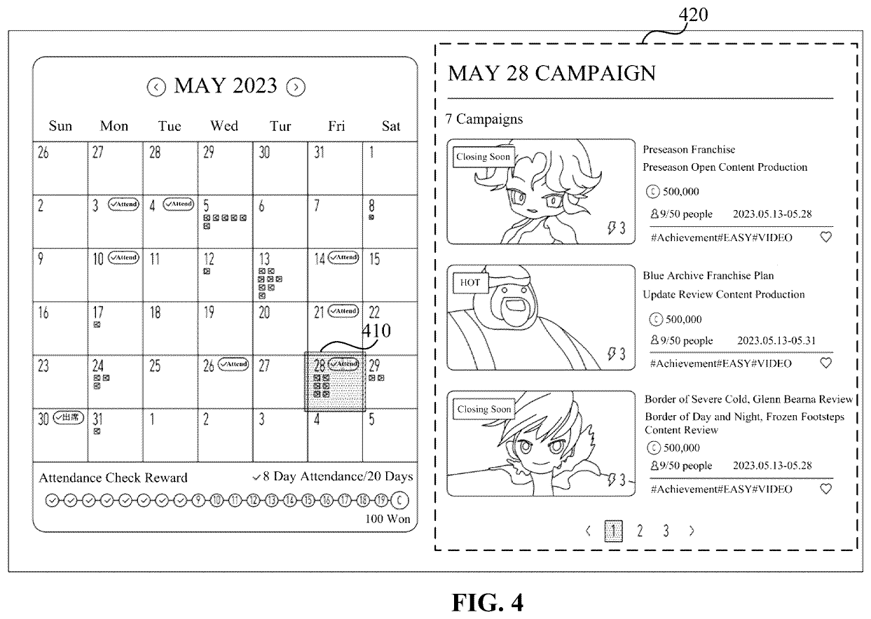

FIG. 4 is a diagram illustrating a creator campaign participation reservation according to an embodiment. Referring to FIG. 4, the controller 130 may mark a campaign, for which a creator has made a participation reservation, on a calendar provided to the creator's account in the form of an icon. For example, as shown in FIG. 4, the participation start date of a creator campaign, for which a participation reservation has been made, may be marked in the form of a ‘>’ icon, and the participation end date thereof may be marked in the form of ‘<.’ When a specific date 410 is selected by a creator, information about a creator campaign, for which a participation reservation has been made, may be provided on the selected date in a campaign tab 420 provided beside the calendar.

Referring to FIG. 4, among the creator campaigns in progress on May 23, there are a total of seven creator campaigns for which a creator has made participation reservations, and two of them have a deadline on May 23. The controller 130 may inform the creator that the deadline for the campaigns is approaching by labeling the corresponding creator campaigns having a deadline on May 23 “Closing Soon” Furthermore, when there is a reservation for participation in a specific campaign, the controller 130 may send a notification message, providing notification that the participation period of the campaign has arrived, to a creator's electronic terminal on the start date of the campaign participation period, and may send a notification message, providing notification that the campaign is about to end, to the creator's electronic terminal on the end date of the campaign participation period.

Meanwhile, the controller 130 may provide a creator campaign interface not only to a creator but also to a supporter and allow the supporter to recommend a campaign to the creators he or she is supporting. For example, in the case where supporter K desires to recommend ‘Blue Archive Franchise Plan’ 330 among the creator campaigns of FIG. 3 to the creators being supported by the supporter K, when supporter K selects ‘Blue Archive Franchise Plan’ 330, the controller 130 may provide the supporter with a pop-up menu including a list of creators being supported by the supporter K and a campaign recommendation button. When supporter K selects at least one creator included in the list and then presses ‘Recommend,’ the controller 130 may notify the selected creator that supporter K has recommended ‘Blue Archive Franchise Plan’ 330.

The controller 130 may deduct the number of participation items set as a condition for participating in a creator campaign from the number of participation items held by the creator member when the creator participates in the campaign. In other words, a creator may require a predetermined number of participation items in order to participate in a specific creator campaign. For example, as shown in the ‘Blue Archive Franchise Plan’ campaign card 330 of FIG. 3, participation items 340 may be shown using a lightning bolt icon and the number 3. This means that three participation items are set as a condition for participating in the ‘Blue Archive Franchise Plan’ campaign.

The number of participation items set as a condition for participating in a creator campaign may be set the same regardless of the creator campaign, as shown in FIG. 3, or may be set based on the type of creator campaign. For example, two participation items may be required when participating in a participation type of creator campaign, and three participation items may be required when participating in an achievement type of creator campaign. Meanwhile, participation items may not be required when participating in a light type of creator campaign. When a creator participates in a creator campaign, the controller 130 may compare the number of participation items required for participating in the creator campaign with the number of participation items held by the creator, and may allow the creator's participation in the campaign only when the number of participation items held by the creator is larger than the number of participation items required for participating in the creator campaign.

The controller 130 may provide one or more participation items to a creator registered as a creator member at regular intervals. For example, the controller 130 may provide 10 participation items at regular intervals, and may provide a different number of participation items according to the level or creator grade of the creator registered as a creator member. Furthermore, a creator registered as a creator member may exchange level-up items for participation items, which will be described in detail later.

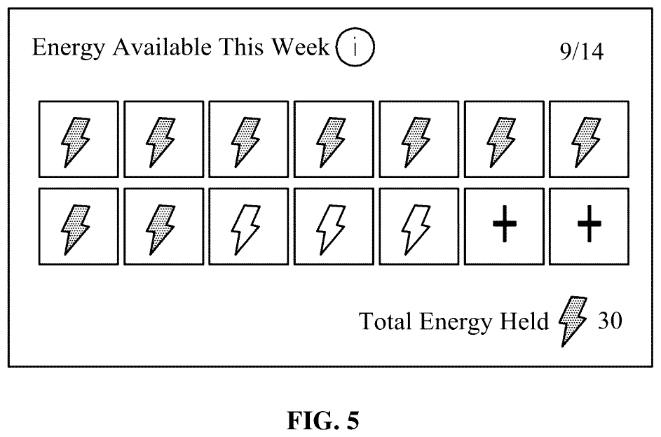

FIG. 5 is a diagram illustrating participation items according to an embodiment. In FIG. 5, the participation items are named energy, and the total number of units of energy held is 30, the total number of units of energy available this week is 14, and the number of units of energy remaining is 9.

Referring to FIG. 5, the controller 130 may set the number of participation items (Energy) available for a specific period of time, i.e., a week, and the number of participation items (Energy) held to be different from each other, so that, even when the number of participation items (Energy) held is larger than the number of participation items (Energy) available, participation items can be used within a usage limit.

According to embodiments, the controller 130 may set a holding limit for participation items, and may set a usage limit for participation items available for a specific period of time and a holding limit for participation items to be the same. For example, when the number of participation items available for use in a week is 14, the controller 130 provides 10 participation items once a week and a creator uses 5 participation items in a week, the controller 130 may provide 5 participation items to the creator, so that the number of participation items available for use can become 14. The controller 130 may restrict the participation of the creator when the usage limit has been exhausted or when the number of participation items held by the creator is smaller than the number of participation items required for participating in the creator campaign.

In order to participate in a creator campaign, there are required a number of participation items equal to the number of participation items set for the creator campaign, and participation items may only be used within a set usage limit for a set period of time, so that there is an advantage in that a specific creator can be prevented from having a monopoly.

Furthermore, the controller 130 may receive campaign content, including campaign performance details, from a creator for participation in the creator campaign. In this case, the controller 130 may directly receive a file including the campaign content from the creator, or may receive the unique address of the campaign content when the creator's campaign content is posted on a video platform. To this end, the controller 130 may access a video platform service such as YouTube or AfreecaTV while operating in conjunction with the corresponding video platform service, and may access the campaign content posted by the creator based on the received unique address of the content.

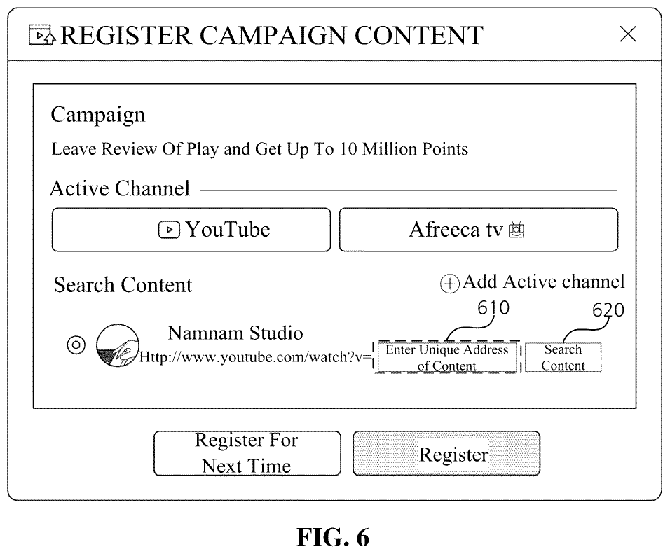

FIG. 6 is a diagram illustrating the submission of campaign content according to an embodiment. Referring to FIG. 6, the controller 130 may provide a creator campaign content registration interface, including a creator campaign name, a video platform selection tab for selecting a creator's active channel, i.e., a video platform where a creator performs activities, a content search tab for registering the unique address of content, and a registration button, to the creator in order to receive campaign content from the creator. The example of FIG. 6 is related to participation in a creator campaign named ‘Leave Nexon Play Review and Get up to 10 Million Points,’ and YouTube is selected as the creator active channel. As shown in the content search tab of the creator campaign content registration interface of FIG. 6, the controller 130 may provide an entry box 610 for receiving only the remaining portion exclusive of the common portion of the unique content address registered on YouTube, i.e., ‘https://www.youtube.com/watch?v=.’ When the creator enters the remaining portion in the entry box 610 and presses a content search button 620, the remaining portion received through the entry box and the common portion, i.e., ‘https://www.youtube.com/watch?v=,’ are combined to generate a unique content address, and information about the content corresponding to the generated unique address is provided, so that the creator can check whether the corresponding content is the campaign content to be submitted.

The controller 130 may determine whether the creator's performance of the creator campaign has been completed based on the submitted campaign content, and may provide rewards to the creator and a supporter for the creator, respectively, when it is determined that the creator's execution of the campaign has been completed.

The controller 130 may provide at least part of a reward for the completion of performance of the campaign to the creator according to preset criteria when the creator's performance of the campaign is completed. More specifically, the controller 130 may provide the overall reward set for the completion of performance of the creator campaign to the creator who has been judged to have completed performing the creator campaign. For example, the ‘Blue Archive Franchise Plan’ campaign 330 shown in FIG. 3 has 500,000 cash set as a reward. When creator A submits participation content for the campaign and is judged to have completed performing the campaign, 500,000 cash may be provided to creator A 10a as a reward.

Alternatively, the controller 130 may provide at least part of the reward for the completion of performance of the creator campaign to the creator depending on the type of creator campaign. For example, in the case of a competition type of creator campaign in which a plurality of creators participate, the reward may be distributed and provided to the creators based on quantitative indicators such as the numbers of subscribers, views, and likes for submitted campaign content. Furthermore, when the type of the creator campaign is an achievement type or a participation type, the controller 130 may receive votes from subscribers or supporters for the campaign content submitted by a plurality of creators, and may distribute the reward set for the creator campaign based on the rankings granted by the votes.

Meanwhile, the controller 130 may distribute part of the reward, provided to the creator, to the supporters. For example, the ‘Blue Archive Franchise Plan’ campaign (330) shown in FIG. 3 offers 500,000 cash as a reward. When creator A submits content for the participation of the campaign and performing the campaign is judged to have been completed, 450,000 cash out of 500,000 cash may be provided to creator A, and 50,000 cash may be distributed to each of supporters B for creator A.

The controller 130 may provide different types of rewards to a creator and a supporter upon the creator's completion of performance of a creator campaign. That is, the controller 130 may provide reward cash to the creator and provide viewer points to the supporters of the creator in substitution for part of the reward cash received by the creator. In other words, the controller 130 may determine the total viewer points, to be distributed to the supporters, to be the same as part of the reward cash received by the creator. When the ‘Blue Archive Franchise Plan’ campaign of FIG. 3 is taken as an example, the controller 130 may provide 500,000 cash, set as a reward for the campaign, to creator A, may determine the total viewer points, to be distributed to the supporters, to be 100,000 points, and may distribute 50,000 viewer points to each of supporters B and C for the creator A.

Meanwhile, according to an embodiment, the controller 130 may provide different numbers of viewer points to supporters according to the supporter grade granted. For example, when there are a plurality of supporter grades and supporter B has a higher grade than supporter C, the controller 130 may provide more viewer points to supporter B than to supporter C. The supporter grade will be described in detail later.

Furthermore, the controller 130 may determine the viewer points to be provided to a supporter based on the contribution of the supporter. For example, the controller 130 may calculate the contribution of the supporter by scoring the numbers of comments, likes, and views written by the supporter for the content of a creator supported by the supporter. Furthermore, the controller 130 may calculate the distribution rate based on the ratio of the contribution of the supporter to the total contribution of all supporters for the creator, and may determine the viewer points to be provided to the supporter by multiplying the calculated distribution rate by the total viewer points to be distributed to all the supporters.

According to the foregoing description, the apparatus 100 for managing creator campaigns according to an embodiment may provide rewards not only to the creator who has completed performing the creator campaign but also to the supporter for the creator. Accordingly, the supporter may also share the benefits of the creator's completion of performance of the campaign, so that the ties between the creator and the supporter can be strengthened.

Meanwhile, when a supporter supports a plurality of creators, the controller 130 may separate and accumulate viewer points for each of the creators supported by the supporter when providing viewer points. Furthermore, the controller 130 may provide a predetermined number of viewer points when a supporter watches the campaign content of the creator supported by the supporter. To this end, the controller 130 may allow the supporter to watch not only campaign content directly uploaded and submitted by the creator, but also campaign content posted on a video platform service, such as YouTube or AfreecaTV, through a separate interface. Furthermore, the controller 130 may allow the supporter to watch the real-time broadcast of the creator, being supported by the supporter, on a video platform service such as YouTube or AfreecaTV through a separate interface, and may also provide predetermined viewer points for the watching of the creator's broadcast.

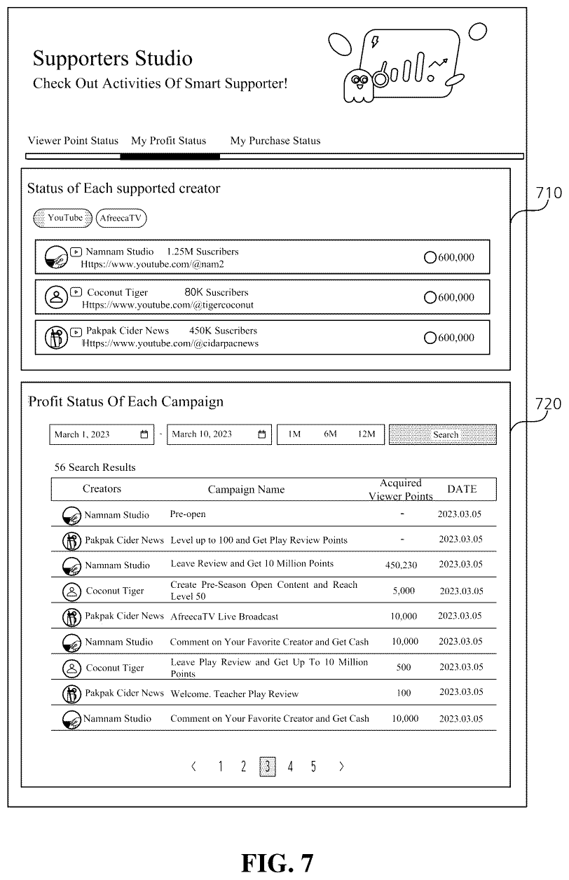

FIG. 7 is a diagram illustrating a supporter-dedicated interface according to an embodiment. Referring to FIG. 7, the supporter-dedicated interface includes supporter viewer point status, my profit status, and my purchase status. Among them, my profit status includes creator status 710 where the details of viewer points acquired and held by each creator being supported by a corresponding supporter can be checked, and per-campaign profit status 720 where the viewer point acquisition status by day is recorded. The supporter is currently supporting three creators, i.e., ‘Namnam Studio’, ‘Coconut Tiger’ and ‘PakPak Cider News’, and holds 600,000 viewer points acquired by each creator.

Meanwhile, the usage range of the reward cash provided to the creator and the usage range of the viewer points provided to the supporter may be set to be different from each other. For example, the usage ranges of the reward cash and the viewer points may be set such that the reward cash received by the creator may be used to purchase items in an in-game item shop, purchase game tickets, or exchange for cash in the ratio of 1:1, whereas the viewer points may be used when the supporter supports the creator or purchase items in a supporter-dedicated market.

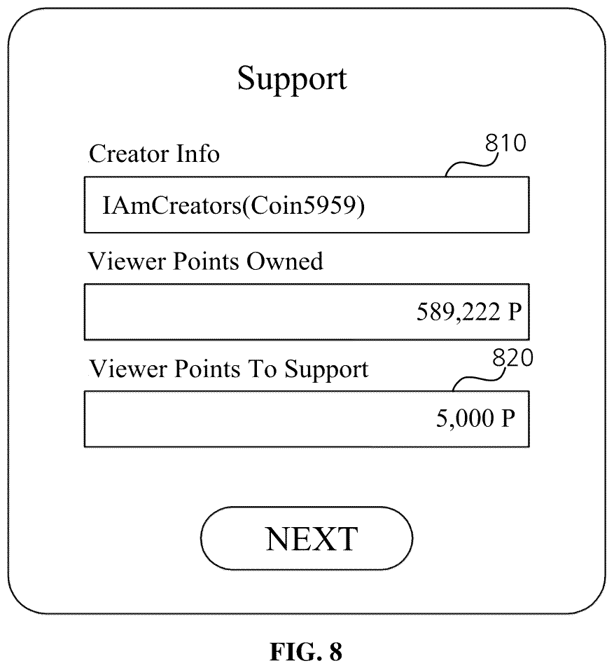

FIG. 8 is a diagram illustrating support for a creator using the viewer points of a supporter according to an embodiment. A supporter may specify a creator to be supported, may enter viewer points for support, and may thus supporter the specified creator with the entered viewer points as support money. For example, as shown in FIG. 8, a supporter may support a creator named ‘I am a creator (coin5959)’ 810 with 5,000 points 820 out of 589,222 points owned by the supporter. The controller 130 may transfer entered viewer points to a specified creator as support money based on creator information and viewer points. In this case, the controller 130 may receive the identification information of a creator to be supported, i.e., the ID or nickname of the creator, from the supporter to specify the creator, and search for the creator based on the entered identification information.

According to an embodiment, when a supporter supports a plurality of creators, setting may be made such that support for each of the creators can be provided only within the range of the viewer points acquired by each of the creators the supporter desires to supporter. That is, when supporter X is registered as a supporter for creator A and creator B, the viewer points acquired by creator A are 3,000 points and the viewer points acquired by creator B are 10,000 points, the viewer points available for support for creator A may be 3,000 points and the viewer points available for support for creator B may be 10,000 points.

According to the foregoing description, the creator is supported using the viewer points received as a reward for the creator's completion of performance of a campaign. Accordingly, the creator may be supported without incurring separate costs. Furthermore, there may be formed a virtuous cycle structure in which the profits obtained from the creator are provided back to the creator.

Meanwhile, the controller 130 may manage one or more creators and one or more supporters registered as members. First, the controller 130 may operate a level system for the creators. More specifically, the controller 130 may grant a basic level, such as level 1, to a creator when he or she registers as a member. Furthermore, the controller 130 may provide experience points to the creator whenever the creator completes performing a campaign. Furthermore, when the accumulated experience points exceed the experience points required for an increase in level, the controller 130 may increase the level of the creator and provide one or more level-up items as a reward for the increase in level. When the level is increased, the controller 130 may deduct the experience points used for the increase in level from the experience points possessed by the creator.

According to an embodiment, the experience points required for an increase in level by one may be the same for all, or all the levels may be divided into a plurality of sections and the experience points required for an increase in level by one may be set differently for each section. For example, the experience points required for an increase in level by one in the section from level 1 to level 5 may be 5, and the experience points required for an increase in level by one in the section from level 5 to level 10 may be 10.

Furthermore, the controller 130 may provide different experience points depending on the type of campaign performed by a creator. For example, the controller 130 may provide 10 experience points when performing a competition type of creator campaign is completed, and may provide 4 experience points when performing a participation type of creator campaign is completed.

Meanwhile, the controller 130 may exchange level-up items for participation items in response to a request from a creator, or may exchange a plurality of level-up items for a single participation item.

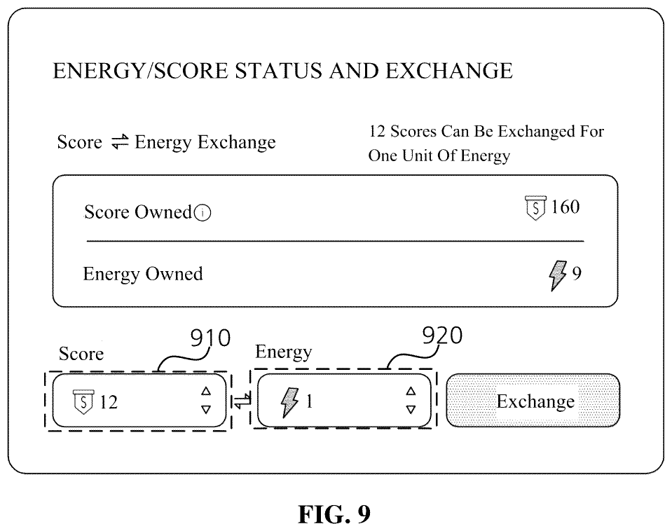

FIG. 9 is a diagram illustrating the exchange of participation items and level-up items according to an embodiment. In FIG. 9, participation items are set to energy and level-up items are set to scores. Referring to FIG. 9, the controller 130 may exchange 12 scores for one unit of energy. The controller 130 may display the number of units of energy 920 to be exchanged based on the number of entered scores 910, or conversely, may display the number of scores 910 required for exchange based on the number of units of energy 920 to be exchanged. Furthermore, when a creator enters the number of scores or the number of units of energy and then presses an exchange button, the controller 130 may deduct the number of scores entered from the number of scores possessed and increase the number of units of energy possessed by the number of units of energy corresponding to the number of scores entered.

In addition, the controller 130 may grant a creator grade based on the level of a creator, and may provide benefits based on the creator grade to the creator member. In other words, the controller 130 may divide creator levels into a plurality of sections in accordance with the number of creator grades, may set the set creator grades in accordance with the respective sections, and may grant a creator grade to a creator based on the section to which the level of the creator belongs. For example, the creator grades may be four grades: NEW, JUNIOR, PRO, and MASTER. The controller 130 may grant a NEW grade to a creator in the section from level 1 to level 5, and may grant a JUNIOR grade to a creator in the section from level 6 to level 10. In the same manner, the controller 130 may grant a PRO grade to a creator in the section from level 11 to level 21, and may grant a MASTER grade to a creator in the section of level 22 or higher.

Meanwhile, according to an embodiment, the controller 130 may change the creator grade of a creator at the same time that the level of the corresponding creator changes. When the level of a creator increases and reaches a specific level, the creator grade of the creator may be changed. For example, when the level of creator A increases from level 5 to level 6, the controller 130 may also increase the creator grade of creator A from NEW to JUNIOR.

The controller 130 may provide different benefits to each creator according to the creator grade. For example, the controller 130 may provide a creator with a specific number of participation items and a specific number of creator-dedicated coupons, which can be gifted to a supporter for the creator, as benefits. The controller 130 may provide a different number of participation items and a different number of creator-dedicated coupons at regular intervals according to the creator grade. As an example, the controller 130 may classify participation items into basic items provided regardless of the creator grade and grade items provided according to the creator grade, and may provide a different number of grade items according to the creator grade.

According to the foregoing description, the apparatus 100 for managing creator campaigns according to an embodiment may provide experience points to a creator whenever the creator completes performing a creator campaign and increase the level of the creator based on the creator's cumulative experience points, thereby motivating the creator to participate in a mission and thus encouraging continuous activity. Furthermore, the apparatus 100 for managing creator campaigns may provide one or more level-up items as a reward for the increase in the level and allow the level-up items to be exchanged for participation items, thereby providing an opportunity for creators having low creator grades to obtain additional participation items.

Meanwhile, the controller 130 may grant a supporter grade to a supporter, and may provide the supporter with benefits according to the supporter grade. According to an embodiment, the controller 130 may grant a supporter grade based on the support money provided to a creator for support and, when a supporter supports a plurality of creators, may grant a supporter grade based on the total amount of support money provided to the creators for support. Furthermore, the supporter grade may be calculated based on the support money provided for support during a preset supporter grade calculation period. As an example, the supporter grade calculation period may be one month immediately before a preset supporter grade calculation date, or three months before a preset supporter grade calculation date.

According to an embodiment, the controller 130 may grant a supporter grade based on a supporter's support money, provided during the supporter grade calculation period, on the supporter grade calculation date. According to an embodiment, the supporter grade may be one of four supporter grades: REGULAR, ROYAL, VIP, and VVIP. For example, a supporter who has provided more than 100,000 won for support may be granted a ROYAL grade, a supporter who has provided more than 500,000 won for support may be granted a VIP grade, and a supporter who has provided more than 2 million won for support may be granted a VVIP level.

The controller 130 may provide different benefits to a supporter according to the supporter grade granted to the supporter, as in the case of benefits provided to a creator. For example, the controller 130 may provide different items, which may be purchased with viewer points, to a supporter according to the supporter grade granted to the supporter.

According to the foregoing description, the apparatus 100 for managing creator campaigns according to an embodiment may grant a supporter grade based on a supporter's support money and provide benefits accordingly, thereby preventing abusive users who register support codes to gain viewer points but do not engage in separate support activities, and also encouraging supporters to continue their activities.

The term “unit” used in the above-described embodiments means software or a hardware component such as a field-programmable gate array (FPGA) or application-specific integrated circuit (ASIC), and a “unit” performs a specific role. However, a “unit” is not limited to software or hardware. A “unit” may be configured to be present in an addressable storage medium, and also may be configured to run one or more processors. Accordingly, as an example, a “unit” includes components, such as software components, object-oriented software components, class components and task components, processes, functions, attributes, procedures, subroutines, segments in program code, drivers, firmware, microcode, circuits, data, a database, data structures, tables, arrays, and variables.

The functions provided in components and “unit(s)” may be combined into a smaller number of components and “unit(s)” or divided into a larger number of components and “unit(s).”

In addition, components and “unit(s)” may be implemented to run one or more central processing units (CPUs) in a device or secure multimedia card.

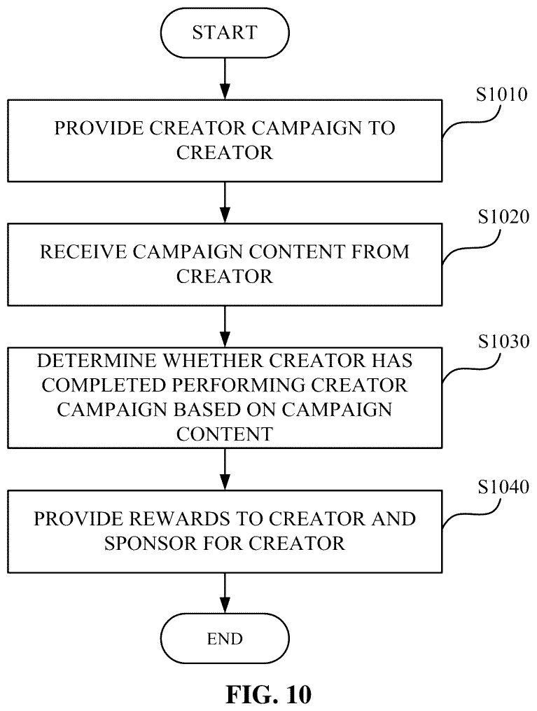

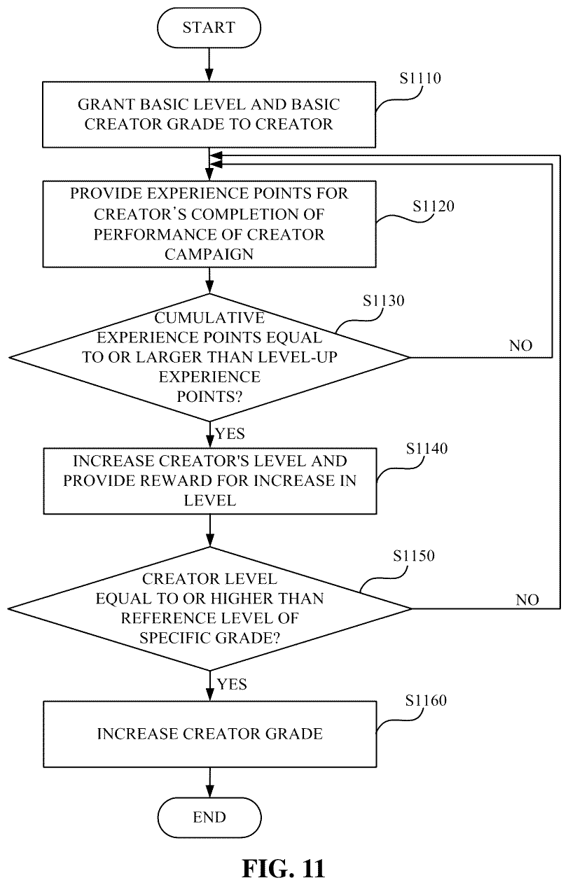

FIGS. 10 and 11 are flowcharts illustrating a method of managing creator campaigns according to an embodiment. The method of managing creator campaigns according to the embodiment shown in FIGS. 10 and 11 includes steps that are processed in a time-series manner in the apparatus 100 for managing creator campaigns shown in FIGS. 1 to 9. Accordingly, the descriptions that are omitted below but have been given above in conjunction with the apparatus 100 for managing creator campaigns shown in FIGS. 1 to 9 may also be applied to the method of managing creator campaigns according to the embodiment shown in FIGS. 10 and 11.

The apparatus 100 for managing creator campaigns may provide a creator campaign to a creator, and may provide rewards to the creator and a supporter for the creator when the creator completes performing the provided creator campaign.

Referring to FIG. 10, the apparatus 100 for managing creator campaigns may provide a creator campaign to a creator in step S1010. The apparatus 100 for managing creator campaigns may provide a campaign only to a creator registered as a member. The campaign provided to the creator may belong to one of a plurality of campaign types classified according to the difficulty to perform. For example, the campaign types may be light, participation, achievement, and competition types.

Next, the apparatus 100 for managing creator campaigns may receive campaign content, including campaign performance content, from the creator for participation in the creator campaign in step S1020. The apparatus 100 for managing creator campaigns may directly receive a file including the campaign content from the creator, or may receive the unique address of the campaign content when the creator's campaign content is posted on a video platform. Meanwhile, the apparatus 100 for managing creator campaigns may deduct the number of participation items set for the creator campaign from the participation items held by the creator for participation in the creator campaign. The participation items may be given a usage limit for a specific period of time. The controller 130 may restrict the participation of the creator when the usage limit has been exhausted or when the number of participation items held by the creator is smaller than the number of participation items required for participating in the creator campaign.

Next, the apparatus 100 for managing creator campaigns may determine whether the creator has completed performing the creator campaign based on received campaign content in step S1030, and, when performing the creator campaign has been completed, may provide rewards to the creator and a supporter for the creator in step S1040.

According to the foregoing description, the method for managing creator campaigns according to an embodiment may provide rewards not only to the creator who has completed performing the creator campaign but also to the supporter for the creator. Accordingly, the supporter may also share the benefits of the creator's completion of performance of the campaign, so that the ties between the creator and the supporter can be strengthened.

Meanwhile, the apparatus 100 for managing creator campaigns may provide experience points to the creator when the creator completes performing the creator campaign, and may change the level of the creator when the cumulative experience points of the creator exceed preset experience points. Furthermore, the apparatus 100 for managing creator campaigns may grant a creator grade to the creator according to the level of the creator, and may provide the creator with benefits based on the creator grade.

FIG. 11 is a flowchart illustrating a process of managing the level and grade of a creator by a method of managing creator campaigns according to an embodiment.

Referring to FIG. 11, the apparatus 100 for managing creator campaigns may grant a basic level and a basic creator grade to a creator when the creator registers for (joins) membership in step S1110. For example, the basic level may be LEVEL 1, and the basic creator grade may be NEW.

Next, the apparatus 100 for managing creator campaigns provides one or more experience points to the creator when it is determined that the creator has completed performing the creator campaign in step S1120. The experience points provided to the creator may vary depending on the type determined by the difficulty of the creator campaign whose performance has been completed by the creator. According to an embodiment, the experience points may be set equally for all creator campaigns regardless of the difficulty of the creator campaign.

The experience points provided to the creator may be accumulated in the creator's account. When the creator's cumulative experience points are equal to or larger than preset experience points, i.e., level-up experience points, in step S1130, the apparatus 100 for managing creator campaigns may increase the creator's level and provide a reward for the increase in level in step S1140. The reward for the increase in level may be one or more level-up items having a special function, or may be reward cash or the like. As described above, the level-up items may be exchanged for participation items, so that creators having a low creator level can obtain additional participation items.

Meanwhile, when the level is increased, the apparatus 100 for managing creator campaigns may deduct the experience points used for the increase in level from the experience points possessed by the creator.

According to an embodiment, the experience points required for an increase in level by one may be the same for all, or all the levels may be divided into a plurality of sections and the experience points required for an increase in level by one may be set differently for each section. For example, the experience points required for an increase in level by one in the section from level 1 to level 5 may be 5, and the experience points required for an increase in level by one in the section from level 5 to level 10 may be 10. That is, when creator K at level 4 has 6 experience points, creator K may increase by one level from level 4 to level 5. Meanwhile, even when creator K at level 4 has 10 experience points, 10 experience points are required to increase from level 5 to level 6, so that creator K's level can increase by only one level from level 4 to level 5.

Meanwhile, when the increased level is equal to or higher than the reference level of a specific grade in step S1150, the apparatus 100 for managing creator campaigns may increase the creator's creator grade in step S1160. For example, when the level of creator N, whose creator grade is JUNIOR, increases by one level from level 10 to level 11, the creator grade of creator N may also be changed from JUNIOR to PRO.

According to the foregoing description, the method of managing creator campaigns according to an embodiment may provide experience points to a creator whenever the creator completes performing a creator campaign and increase the level of the creator based on the creator's cumulative experience points, thereby motivating the creator to participate in a mission and thus encouraging continuous activity.

Each of the methods of managing creator campaigns according to embodiments described through FIGS. 10 and 11 may be implemented in the form of a computer-readable medium that stores instructions and data that can be executed by a computer. In this case, the instructions and the data may be stored in the form of program code, and may generate a predetermined program module and perform a predetermined operation when executed by a processor. Furthermore, the computer-readable medium may be any type of available medium that can be accessed by a computer, and may include volatile, non-volatile, separable and non-separable media. Furthermore, the computer-readable medium may be a computer storage medium. The computer storage medium may include all volatile, non-volatile, separable and non-separable media that store information, such as computer-readable instructions, a data structure, a program module, or other data, and that are implemented using any method or technology. For example, the computer storage medium may be a magnetic storage medium such as an HDD, an SSD, or the like, an optical storage medium such as a CD, a DVD, a Blu-ray disk or the like, or memory included in a server that can be accessed over a network.

Furthermore, each of the methods of managing creator campaigns according to embodiments described through FIGS. 10 and 11 may be implemented as a computer program (or a computer program product) including computer-executable instructions. The computer program includes programmable machine instructions that are processed by a processor, and may be implemented as a high-level programming language, an object-oriented programming language, an assembly language, a machine language, or the like. Furthermore, the computer program may be stored in a tangible computer-readable storage medium (for example, memory, a hard disk, a magnetic/optical medium, a solid-state drive (SSD), or the like).

Accordingly, each of the methods of managing creator campaigns according to embodiments described through FIGS. 10 and 11 may be implemented in such a manner that the above-described computer program is executed by a computing apparatus. The computing apparatus may include at least some of a processor, memory, a storage device, a high-speed interface connected to memory and a high-speed expansion port, and a low-speed interface connected to a low-speed bus and a storage device. These individual components are connected using various buses, and may be mounted on a common motherboard or using another appropriate method.

In this case, the processor may process instructions within a computing apparatus. An example of the instructions is instructions which are stored in memory or a storage device in order to display graphic information for providing a Graphic User Interface (GUI) onto an external input/output device, such as a display connected to a high-speed interface. As another embodiment, a plurality of processors and/or a plurality of buses may be appropriately used along with a plurality of pieces of memory. Furthermore, the processor may be implemented as a chipset composed of chips including a plurality of independent analog and/or digital processors.

Furthermore, the memory stores information within the computing device. As an example, the memory may include a volatile memory unit or a set of the volatile memory units. As another example, the memory may include a non-volatile memory unit or a set of the non-volatile memory units. Furthermore, the memory may be another type of computer-readable medium, such as a magnetic or optical disk.

In addition, the storage device may provide a large storage space to the computing device. The storage device may be a computer-readable medium, or may be a configuration including such a computer-readable medium. For example, the storage device may also include devices within a storage area network (SAN) or other elements, and may be a floppy disk device, a hard disk device, an optical disk device, a tape device, flash memory, or a similar semiconductor memory device or array.

The above-described embodiments are intended for illustrative purposes. It will be understood that those having ordinary knowledge in the art to which the present invention pertains can easily make modifications and variations without changing the technical spirit and essential features of the present invention. Therefore, the above-described embodiments are illustrative and are not limitative in all aspects. For example, each component described as being in a single form may be practiced in a distributed form. In the same manner, components described as being in a distributed form may be practiced in an integrated form.

The scope of protection pursued through the present specification should be defined by the attached claims, rather than the detailed description. All modifications and variations which can be derived from the meanings, scopes and equivalents of the claims should be construed as falling within the scope of the present invention.

What is claimed is:

1. An apparatus for managing creator campaigns, the apparatus comprising:
memory; and
a controller configured to provide a creator campaign and provide a reward to a supporter for a creator who has completed performing the creator campaign.

2. The apparatus of claim 1, wherein the controller provides viewer points to the supporter for the creator as the reward, and provides viewer points, entered by the supporter, as support money for the creator.

3. The apparatus of claim 1, wherein the controller provides a reward, set for the creator campaign, to the creator who has completed performing the creator campaign.

4. The apparatus of claim 1, wherein the creator who has completed performing the creator campaign comprises a plurality of creators, and the controller distributes the reward, set for the creator campaign, to the plurality of creators who have completed performing the creator campaign according to predetermined criteria.

5. The apparatus of claim 4, wherein the controller distributes the reward, set for the creator campaign, to the plurality of creators based on at least one of rankings, numbers of views, and numbers of likes for respective pieces of content submitted by the plurality of creators for participation in the creator campaign.

6. The apparatus of claim 1, wherein the controller:
provides one or more experience points to the creator who has completed performing the creator campaign; and
when cumulative experience points of the creator are equal to or larger than a preset reference, increases a level of the creator and provides one or more level-up items to the creator as the reward.

7. The apparatus of claim 6, wherein the controller grants a creator grade to the creator based on the level of the creator, and provides benefits to the creator according to the granted creator grade.

8. The apparatus of claim 1, wherein the controller deducts a specific number of participation items set for the creator campaign from participation items held by the creator within a preset usage limit for a predetermined period of time for participation in the creator campaign.

9. The apparatus of claim 8, wherein the controller provides one or more participation items to the creator at regular intervals, the controller providing the participation items according to the creator grade of the creator.

10. The apparatus of claim 1, wherein the controller sets a participation reservation for a creator campaign selected by the creator, and marks and provides the creator campaign, for which the participation reservation has been made, on the creator's calendar.

11. A method of managing creator campaigns, the method being performed by an apparatus for managing creator campaigns, the method comprising:
providing a creator campaign; and
providing a reward to a supporter for a creator who has completed performing the creator campaign.

12. The method of claim 11, wherein:
providing the reward comprises providing viewer points to the supporter for the creator as the reward; and
the method further comprises providing viewer points, entered by the supporter, as support money for the creator.

13. The method of claim 11, wherein providing the reward comprises providing a reward, set for the creator campaign, to the creator who has completed performing the creator campaign.

14. The apparatus method of claim 11, wherein:
the creator who has completed performing the creator campaign comprises a plurality of creators; and
providing the reward comprises distributing the reward, set for the creator campaign, to the plurality of creators who have completed performing the creator campaign according to predetermined criteria.

15. The method of claim 14, wherein distributing the reward comprises distributing the reward, set for the creator campaign, to the plurality of creators based on at least one of rankings, numbers of views, and numbers of likes for respective pieces of content submitted by the plurality of creators for participation in the creator campaign.

16. The method of claim 11, wherein:
providing the reward comprises providing one or more experience points to the creator who has completed performing the creator campaign; and
the method further comprises, when cumulative experience points of the creator are equal to or larger than a preset reference, increasing a level of the creator and providing one or more level-up items to the creator as the reward.

17. The method of claim 16, further comprising:
granting a creator grade to the creator based on the level of the creator; and
providing benefits to the creator according to the granted creator grade.

18. A non-transitory computer-readable storage medium having stored thereon a program that, when executed by a processor, causes the processor to execute the method of managing creator campaigns set forth in claim 11.

19. A computer program that is executed by an apparatus for managing creator campaigns and stored in a non-transitory computer-readable storage medium to perform the method of managing creator campaigns set forth in claim 11.
